(19) United States
(12) Patent Application Publication
(10) Pub. No.: US 2025/0279968 A1
(43) Pub. Date: Sep. 4, 2025

(54) FLOW BASED CONTROL PLANE PROTECTION

(71) Applicant: Arista Networks, Inc., Santa Clara, CA (US)

(72) Inventors: Michael Kerby Chen, Palo Alto, CA (US); Francois Labonte, Menlo Park, CA (US); Kartik Chandran, Los Altos, CA (US)

(21) Appl. No.: 18/592,142

(22) Filed: Feb. 29, 2024

(51) Int. Cl. H04L 47/25; H04L 47/20

(52) U.S. Cl. CPC H04L 47/25; H04L 47/20

(57) ABSTRACT

A method of operating a network device that includes at least a first processor and a second processor is provided. The method can include receiving data packets with the first processor, determining whether the data packets are control plane packets to be processed by the second processor, determining whether the data packets match a given flow in response to determining that the data packets are control plane packets, and limiting a flow rate of the data packets sent to the second processor by a first amount in response to determining that the data packets match the given flow. The method can further include limiting a flow rate of the data packets sent to the second processor by a second amount different than the first amount in response to determining that the data packets do not match the given flow.

### BACKGROUND

A communication system can include multiple network devices that are interconnected to form a network for conveying packets from a source device to a destination device. Routing information indicating the route through which the packets are to be conveyed from the source device to the destination device can be shared amongst peer network devices using the Border Gateway Protocol (BGP) established over corresponding Transmission Control Protocol (TCP) sessions between pairs of peer network devices.

Consider a scenario in which a network device receives packets from many BGP peer network devices. The network device can include a central processing unit (CPU) and a single static component that limits the rate for CPU-bound packets from all BGP peer network devices unilaterally. Configured in this way, a single misbehaving peer device can overwhelm the single static component, causing incoming packets from all other peer devices to be dropped. It is within such context that the embodiments herein arise.

### BRIEF DESCRIPTION OF THE DRAWINGS

FIG. 1 is a diagram of an illustrative system having one or more network devices in accordance with some embodiments.

FIG. 2 is a diagram of an illustrative network device having one or more subsystems configured to provide flow based control plane protection in accordance with some embodiments.

FIG. 3 is a flowchart of illustrative steps for operating the network device shown in FIG. 2 in accordance with some embodiments.

FIG. 4 is a diagram showing illustrative hardware components within a data processing system in accordance with some embodiments.

### DETAILED DESCRIPTION

A network device such as a switch or router may receive data packets from one or more neighboring network devices. The network device can include one or more processors, including a packet processor and a central processing unit (CPU). The packet processor can include a packet forwarding database, a CPU traffic policy database, control plane policers, and one or more flow policers. The packet forwarding database can be configured to receive incoming packets and to determine whether the incoming packets are control plane packets intended to be processed by the local CPU within that network device (e.g., by matching predefined or configurable criteria in the incoming packet). The CPU traffic policy database can be configured to receive control plane packets from the packet forwarding database and to apply configuration actions to the control plane packets. The packet forwarding database can be implemented as a content addressable memory (CAM). The CPU traffic policy database can be implemented as another content addressable memory (CAM). One way the CPU traffic policy database can be configured is to match or identify packets associated with a given flow. Packets matching the given flow may then be conveyed to a corresponding flow policer configured to rate-limit that particular flow. Other (non-matching) packets may be conveyed to one of the control plane policers, which generally manages packet flow rate for specific networking protocols.

The policers can then output the control plane packets to the CPU. Packet processing software such as a kernel driver within the CPU can receive the control plane packets and forward the received control plane packets to a corresponding flow table. The flow table can gather flow data and associated flow rate statistics for different flows. The term “flow” may generally refer to a stream of related packets for communicating with another device or application. For example, a specific flow can be identified by a 5-tuple source address, destination address, protocol, source port, and destination port. More generally, a flow can refer to any stream of communication that can be identified by a unique set of identifiers. If a particular flow is causing incoming packets to be dropped, a policer manager executed on the CPU can dynamically program a flow matching entry in the CPU traffic policy database corresponding to that flow and can dynamically install or selectively activate a flow policer to rate-limit that flow. The policer manager can optionally uninstall or deactivate the flow policer and/or remove the flow matching entry from the CPU traffic policy database if that flow is no longer causing dropped packets or if the flow rate satisfies some other criteria. A network device configured and operated in this way can be technically advantageous and beneficial to provide higher resolution and efficient control plane protection by targeting only one or more specific flows.

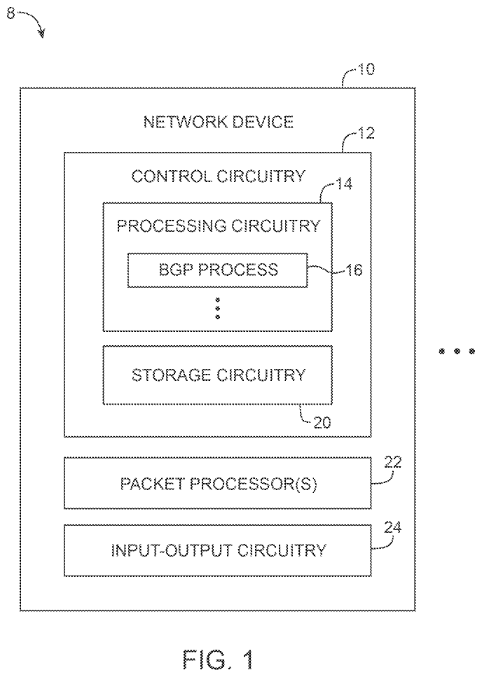

An illustrative networking system configured to provide a process for selectively delaying the processing of inbound BGP routes is shown in FIG. 1. As shown in FIG. 1, networking system 8 may include one or more network devices 10. Each network device 10 in system 8 may be a switch (e.g., a multi-layer L2/L3 switch), a router or gateway, a bridge, a hub, a repeater, a firewall, a wireless access point, a device serving other networking functions, a device that includes a combination of these functions, or other types of network devices. Multiple such network devices having the same or different networking functions in system 8 may be present and interconnected to form a communications network that processes and/or forwards traffic (e.g., data packets) between end hosts.

The communications network may be implemented with any suitable scope (e.g., as a wide area network, including one or more campus area networks or including one or more local area networks, etc.). If desired, the communications network may include internet service provider networks (e.g., the Internet) or other public service provider networks, private service provider networks (e.g., multiprotocol label switching (MPLS) networks), and/or may include other types of networks such as telecommunication service provider networks (e.g., a long-term evolution (LTE) network).

As shown in FIG. 1, network device 10 may include control circuitry 12, one or more packet processor(s) 22, and input-output circuitry 24 disposed within a housing of network device 10. Control circuitry 12 may include processing circuitry 14 and storage circuitry 20. The housing of network device 10 may include an exterior cover (e.g., a plastic exterior shell, a metal exterior shell, or an exterior shell formed from other rigid or semirigid materials) that provides structural support and protection for the components of network device 10 disposed within the housing.

Processing circuitry 14 may include one or more processors or processing units based on central processing units (CPUs), graphics processing units (GPUs), microprocessors, general-purpose processors, host processors, microcontrollers, digital signal processors, programmable logic devices such as a field programmable gate array device (FPGA), application specific system processors (ASSPs), application specific integrated circuit (ASIC) processors, and/or other types of processors. Processing circuitry 14 may run (execute) a network device operating system and/or other software/firmware that is stored on storage circuitry 20.

Storage circuitry 20 may include non-transitory (tangible) computer readable storage media configured to store the operating system software and/or any other software code, sometimes referred to as program instructions, software, data, instructions, or code. As an example, the operations described herein for selectively delaying routes as well as other network device data plane functions may be stored as (software) instructions on the non-transitory computer-readable storage media (e.g., in portion(s) of storage circuitry 20 in network device 10). The corresponding processing circuitry (e.g., one or more processors of processing circuitry 14 in network device 10) may process or execute the respective instructions to perform the corresponding operations. Storage circuitry 20 may be implemented using non-volatile memory (e.g., flash memory or other electrically-programmable read-only memory configured to form a solid-state drive), volatile memory (e.g., static or dynamic random-access memory), hard disk drive storage, and/or other storage circuitry. Storage circuitry 20 is therefore sometimes referred to as memory circuitry. Processing circuitry 14 and memory circuitry 20 as described above may sometimes be referred to collectively as control circuitry 12 implementing a control plane of network device 10.

In particular, processing circuitry 14 may execute control plane software such as operating system software, routing policy management software, routing protocol agents or processes (e.g., one or more BGP processes such as an active BGP process 16), and other software, may be used to support the operation of protocol clients and/or servers, may be used to support the operation of packet processor(s) 22, may store packet forwarding information, may execute packet processing software, and/or may execute other software instructions that control the functions of network device 10 and the other components therein. While processing circuitry 14 is primarily described herein as executing one or more BGP processes, processing circuitry 14 may also execute one or more other network routing protocol agents or processes. As examples, these other network protocol agents may implement Bidirectional Forwarding Detection (BFD) protocol, Address Resolution Protocol (ARP), Internet Group Management Protocol (IGMP), Link Aggregation Control Protocol (LACP), non-BGP distance vector routing protocols, Protocol Independent Multicast (PIM) protocols, Resource Reservation Protocol (RSVP), Link Layer Discovery Protocol (LLDP), Spanning Tree Protocol (STP), Virtual Extensible LAN (VXLAN) protocol, Two-Way Active Measurement Protocol (TWAMP), Precision Time Protocol (PTP), Connectivity Fault Management (CFM) protocol, Enhanced Interior Gateway Routing Protocol (EIGRP), Exterior Gateway Protocol (EGP), Routing Information Protocol (RIP), Open Shortest Path First (OSPF) protocol, Label Distribution Protocol (LDP), Multiprotocol Label Switching (MPLS), Intermediate System to Immediate System (IS-IS) protocol, or other Internet routing protocols (just to name a few).

Packet processor(s) 22 may be used to implement a data plane or forwarding plane of network device 10. Packet processor(s) 22 may include one or more processors or processing units based on central processing units (CPUs), graphics processing units (GPUs), microprocessors, general-purpose processors, host processors, microcontrollers, digital signal processors, programmable logic devices such as a field programmable gate array device (FPGA), application specific system processors (ASSPs), application specific integrated circuit (ASIC) processors, and/or other processor architectures.

Packet processor 22 may receive incoming data packets via input-output circuitry 24 (e.g., ports), parse and analyze the received data packets, process the packets based on packet forwarding decision data (e.g., in a forwarding information base) and/or in accordance with a network protocol, and forward (or drop) the data packet accordingly. The packet forwarding decision data may be stored on a portion of memory circuitry 20 and/or other storage circuitry integrated as part of or separate from packet processor 22. Input-output circuitry 24 may include communication interface components such as one or more Bluetooth interface, Wi-Fi interface, Ethernet interface, optical interface, and/or other wired or wireless network interfaces for connecting network device 10 to the Internet, a local area network, a wide area network, a mobile network, other types of networks, and/or to another network device, peripheral devices, and/or other electronic equipment. Network device 10 may also include other components such as a system bus or connector(s) that couple the components of network device 10 to one another, power management components, thermal management components, etc.

In the example of FIG. 1, processing circuitry 14 may execute (run) a BGP process such as active BGP process 16 to exchange network routing information and network device capabilities with other network devices (sometimes referred to herein as peer network devices, peer devices, or “peers” of network device 10). Active BGP process 16 can sometimes be referred to as the primary BGP process. In particular, network device 10 may establish a TCP session with each peer and may exchange BGP messages over each of these TCP sessions with a corresponding peer network device. Use of TCP sessions to link together multiple peers in a BGP network is merely illustrative. If desired, other types of network communication links, sessions, or paths can be employed. The exchanged network routing information may be used to generate or otherwise inform the packet forwarding decision data and therefore the packet forwarding behavior of packet processor 22, among other functions.

Consider a scenario in which a network device receives packets from many neighboring network devices. The network device can include a single static component that limits the rate for packets intended for the local CPU from all neighboring network devices unilaterally. Configured in this way, a single misbehaving neighboring device can overwhelm the single static component, causing incoming packets from all other neighboring network devices to be dropped.

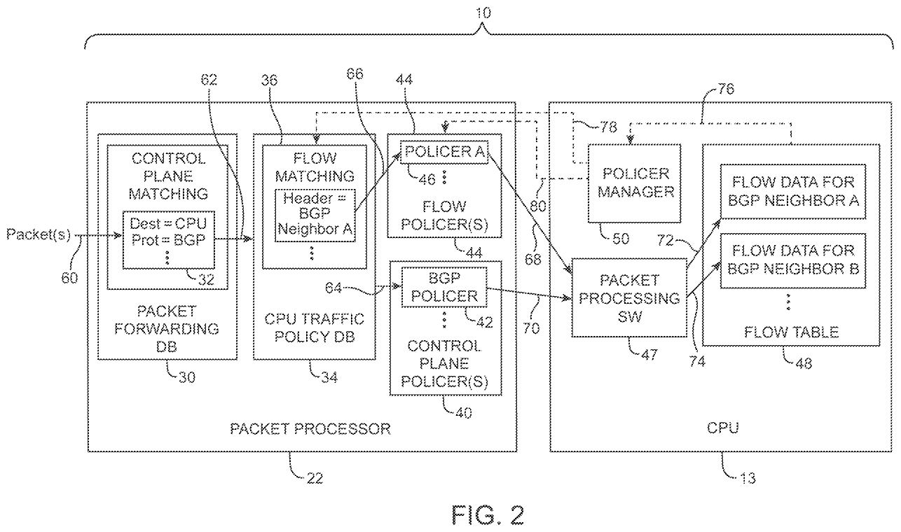

In accordance with an embodiment, network device 10 can include circuitry configured to control plane protection for a particular flow (traffic) from a specific neighboring device. Such type of protection in which control plane protection is provided for specific or targeted flow(s) is sometimes referred to herein as flow based control plane protection. FIG. 2 is a diagram of network device 10 having one or more hardware and/or software subsystems configured to provide flow based control plane protection. As shown in FIG. 2, network device 10 can include packet processor 22 communicatively coupled to CPU 13. CPU 13 may represent one or more processors that are part of control circuitry 12 of FIG. 1. The example of FIG. 2 in which device 10 is shown as including a packet processor 22 and a separate CPU is illustrative. In general, network device 10 can include two or more processors. In yet other embodiments, packet processor 22 and CPU 13 can optionally be implemented as part of a single processing unit or system on a chip (SoC).

Packet processor 22 may include one or more databases such as a packet forwarding database 30 and a CPU traffic policy database 34 and one or more policers such as control plane policer(s) 40 and flow policers 44. Control plane policers 40 and flow policers 44 can optionally be implemented using the same group of hardware resources. Both the control plane policers 40 and the flow policers 44 are configured to limit the flow rate of data packets and can thus collectively be referred to as flow rate policers or rate limiting subsystems. Packet forwarding database 30 can be configured to store one or more entries that can be used to perform control plane matching (see block 32). “Control plane matching” can refer to and be defined herein as operations relating to determining whether incoming packets on input or ingress path 60 are intended to be processed at device 10. Packets that are intended to be processed at device 10 (e.g., packets intended to be processed by the local CPU 13) can be referred to as “control plane packets.” In contrast, packets that are merely traversing device 10 without being processed by the local CPU 13 can be referred to as “data plane packets.”

In the example of FIG. 2, packets having a destination corresponding to the IP address of device 10 (i.e., an IP address corresponding to the local CPU 13) and having a protocol corresponding to BGP would be matched or identified by block 32 as being control plane packets. Such entries for control plane matching (identification) in packet forwarding database 30 can be configured on network device 10 to handle one or more networking protocols and are optionally hidden from or not configurable by the user/administrator of device 10. Packet forwarding database 30 is therefore sometimes referred to as a database having control plane matching entries. As an example, packet forwarding database 30 can be implemented as content-addressable memory such as ternary content-address memory (TCAM) or other types of memory for matching data. This example in which the matching criteria of block 32 is static or predefined is illustrative. If desired, the matching criteria of block 32 are optionally user configurable. Data packets that do not match any entry in packet forwarding database 30 may be considered data plane packets and can be processed internally within packet processor 22 before being forwarded to another network device via a corresponding egress port without ever having been processed by the local CPU 13.

Control plane packets identified by the packet forwarding database 30 can be forwarded to CPU traffic policy database 34, as shown by path 62. CPU traffic policy database 34 can be configured to store one or more entries for performing flow matching (see block 36) or to perform other configurable actions on the control plane packets. “Flow matching” can refer to and be defined herein as operations relating to determining whether control plane packets correspond to or match one or more parameters of a particular flow. In the example of FIG. 2, control plane packets having header information corresponding to a particular BGP peer A would be matched or identified by block 36 as belonging to or associated with the particular flow A. BGP peer A can represent any device along the path to network device 10 (e.g., BGP peer A can go through one or more hops/devices before arriving at device 10). In other words, BGP peer A does not have to be the device that is immediately connected to device 10. As an example, at least a portion of the header information can include a 5-tuple, which specifies a source address, a destination address, a network protocol, a source port, and a destination port. BGP peer A can be specified in the destination address in the header field (e.g., using either IPv4 or IPv6 destination address) or in other routable address in the header. Any packets having the same (matching) 5-tuple can be considered as belonging to or associated with the same flow.

In general, however, a “flow” can refer to any stream of data that is identified by a unique set of identifiers (e.g., a one-tuple, a 2-tuple, a 3-tuple, a 4-tuple, a 5-tuple, a 6-tuple, or any collection of packet identification values/parameters). Packets matching the particular flow can then be conveyed to a corresponding flow policer 46 configured to rate-limit that particular flow, as indicated by arrow 66. Other non-matching packets may be conveyed to one or more of the control plane policers 40, which generally manages packet flow rate for specific network protocols. In this example, non-matching BGP packets would be forwarded to a BGP policer 42 within the control plane policers 40, as indicated by arrow 64. The examples described herein in which CPU traffic policy database 34 is used to determine whether data packets are associated with a given flow by examining the 5-tuple header information are illustrative. More generally, packet processor 22 can be configured to determine whether the data packets satisfy a set of criteria. In response to determining that the data packets satisfy the set of criteria, the data packets can be conveyed to flow policer(s) 44. In response to determining that the data packets do not satisfy the set of criteria, the data packets can be conveyed to flow policer(s) 40.

The entries for flow matching, sometimes referred to as flow identification, in CPU traffic policy database 34 can be dynamically configured by the user/administrator of device 10. Alternatively or additionally, such entries can be automatically managed by software running on device 10 (e.g., by policer manager 50 executed or running on CPU 13). CPU traffic policy database 34 is therefore sometimes referred to as a dynamic database having dynamically configurable flow matching entries. As an example, CPU traffic policy database 34 can be implemented as another content-addressable memory such as ternary content-address memory (TCAM) or other types of memory for matching data. More generally, databases 30 and 34 can be implemented as content address memory having a first set of entries that is used to determine whether the data packets are destined for the control plane processing circuitry and having a second set of entries that is used to determine whether the data packets are part of a given flow.

In general, flow policers 44 can represent one or more hardware components for limiting the flow rate of various CPU-bound traffic. If desired, flow policers 44 can include two or more separate policers 46 that are configured to limit the flow rate for a first flow A (e.g., traffic from a first peer A), to limit the flow rate for a second flow B (e.g., traffic from a second peer B), to limit the flow rate for a third flow C (e.g., traffic from a third peer C), to limit the flow rate for a fourth flow D (e.g., traffic from a fourth peer D), etc. Flow policers 44 can be dynamically installed (activated) or uninstalled (removed or deactivated) by policer manager 50 and are thus sometimes referred to as “dynamic” policers.

In contrast to the dynamic flow policers, control plane policers 40 can include one or more preconfigured or preassigned control plane policers for managing the packet flow rate for specific network protocols. Such types of preconfigured control plane policers 40 are sometimes referred to as “static” policers. In some embodiments, control plane policers 40 can optionally be configured to limit packet flow rate to the CPU on a per-interface basis (e.g., the control plane policers can be configured to limit flow rate on a per-protocol and/or per-interface basis). In general, the static control plane policers 40 can include two or more separate policers 42 configured to limit the flow rate for different protocols, such as a first policer 42 for limiting the flow rate for all BGP control plane packets, a second policer 42 for limiting the flow rate for all BFD control plane packets, a third policer 42 for limiting the flow rate for all ARP control plane packets, a fourth policer 42 for limiting the flow rate for all IGMP control plane packets, etc. If desired, control plane policers 40 can optionally be dynamically reconfigured by policer manager 50.

In general, policers 44 can be configured to limit the flow rate of control plane packets by one or more first amount(s), where policers 40 can be configured to limit the flow rate of control plane packets by one or more second amount(s) different than the first amount(s). In general, policers 44 can impose a lower flow rate limit than policers 40 (e.g., policers 44 can restrict the flow rate more than policers 40). In other words, policers 44 can limit the flow rate of data packets to a first value, whereas policers 40 might limit the flow rate of data packets to a second value greater than the first value. The various subsystems such as packet forwarding database 30, CPU traffic policy database 34, policers 40, policers 44, and other components that are part of packet processor 22 can be referred to collectively as packet processing circuitry.

Rate-limited control plane packets output from a dynamic flow policer 46 (or 44) can be conveyed to the control plane of network device 10 and, for example, received by packet processing software 47 executed on CPU 13 as shown by arrow 68. Rate-limited control plane packets output from a static control plane policer 42 (or 40) can also be conveyed to the control plane of network device 10 and, for example, received by packet processing software 47 as shown by arrow 70. Packet processing software 47 may be a specialized program or code running in a kernel (low level) space that allows the operating system of device 10 to communicate with and control the various hardware resources on device 10. Packet processing software 47, sometimes implemented as a kernel driver, can be part of the main operating system of network device 10.

Packets received at packet processing software 47 can be forwarded to and to populate a flow table 48. Packets received from different neighbor (peer) devices can populate different entries in flow table 48. In the example of FIG. 2, flow data associated with packets received from a first BGP neighbor can be stored in a first entry (as shown by arrow 72), whereas flow data associated with packets received from a second BGP neighbor can be stored in a second entry (as shown by arrow 74). The flow data can include flow rate (e.g., in terms of bits or bytes per second or other packet flow metric) and/or other flow rate statistics information. The example of FIG. 2 in which flow table 48 includes flow data for two different flows or neighbors is illustrative. In general, flow table 48 can be configured to store flow rate information corresponding to two or more different neighbor devices, three or more different neighbor devices, three to ten neighbor devices, 10 to 100 neighbor devices, or more than 100 neighbor devices. After flow table 48 has been updated based on the arriving control plane packets, the control plane packets can then be processed by CPU 13 to perform any desired control plane level processing or function. As examples, CPU 13 may be configured to perform routing protocol processing, access control list processing, quality of service (QOS) management, security policy enforcement, error handling and logging, and/or other management plane operations based on the information in the received control plane packets.

Policer manager 50 may represent a software or optionally hardware component implemented on CPU 13 for dynamically configuring the CPU traffic policy database 34 and flow policers 44 based on the flow statistics being gathered at flow table 48. Policer manager 50 can monitor or receive inputs from flow table 48 and, based on the monitored or received information, program one or more flow matching entries within CPU traffic policy database 34 (see, e.g., control path 78). For example, in response to detecting that a particular flow is exceeding a threshold flow rate, is causing packets from other neighboring devices to drop, and/or is otherwise recognized as being somehow received from a potentially misbehaving or malicious neighbor device, policer manager 50 can program CPU traffic policy database 34 with an entry having a 5-tuple or other header/identifier information corresponding to that particular flow. In such scenarios, policer manager 50 can also install a corresponding flow policer 46 to specifically target and limit the flow rate for that particular flow (see, e.g., control path 80). Operated in this way, incoming packets matching the configured 5-tuple identifier or other header/identifier information would be forwarded to the corresponding flow policer 46 to prevent packets in that particular flow from overwhelming CPU 13. The various subsystems such as packet processing software 47, flow table 48, policer manager 50, and/or other components that are part of CPU 13 can be referred to collectively as control plane processing circuitry.

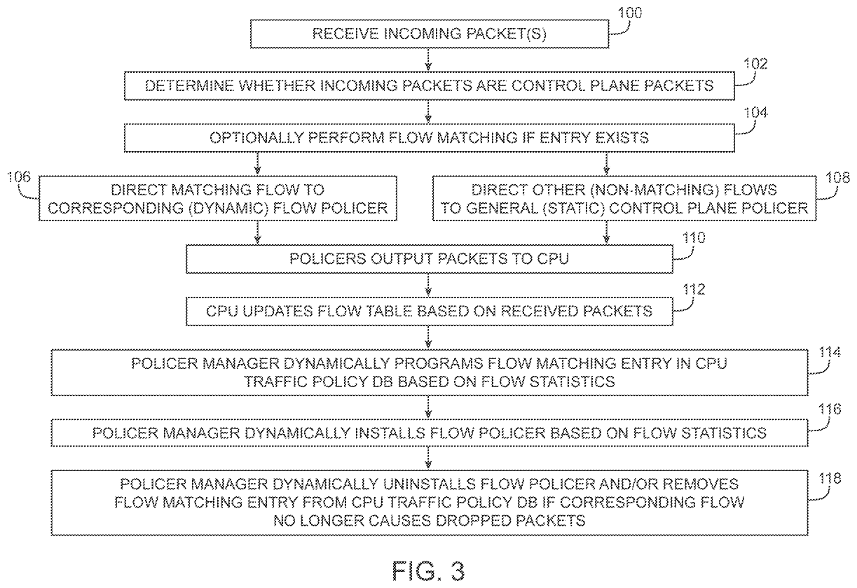

FIG. 3 is a flowchart of illustrative steps for operating network device 10 of the type described in connection with FIG. 2. During the operations of block 100, network device 10 can receive incoming data packets. The incoming data packets can be received at one or more ingress ports and conveyed to packet processor 22.

During the operations of block 102, network device 10 can be configured to determine whether the incoming data packets are control plane packets. For example, packet forwarding database 30 may perform control plane matching operations (e.g., by analyzing the destination address of the data packets and optionally the communication protocol of the data packets) to determine whether those packets are intended to be processed by the local CPU 13 within that network device 10.

If the control plane matching operations return a positive result (e.g., if the incoming data packets include information matching an entry in packet forwarding database 30), the data packets can be considered control plane packets from this point forward and can be conveyed to CPU traffic policy database 34 to perform flow matching operations (see operations of block 104). If the control plane matching operations return a negative result (e.g., if the incoming data packets do not include any information matching an entry in packet forwarding database 30), the data packets can be considered data plane packets from this point forward and need not be processed by the local CPU 13.

During flow matching operations of block 104, packet processor 22 may determine whether the incoming packets include header information (e.g., a 5-tuple identifier) corresponding to a particular flow. For example, packet processor 22 may determine whether the 5-tuple identifier of a data packet matches an entry within the CPU traffic policy database 34.

In response to the flow matching operations returning a positive result or match, those data packets can be conveyed to a corresponding dynamic flow policer (see, e.g., policer 46 in FIG. 2), as shown in the operations of block 106. Dynamic flow policer 46 can be configured to limit the rate or speed for that particular flow. The rate limit of a dynamic flow policer 46 can be any configurable flow rate that can suppress undesirable network behavior.

In response to the flow matching operations returning a negative result (i.e., no match), those non-matching data packets can be conveyed to a corresponding general (static) control plane policer (see, e.g., policer 42 in FIG. 2), as shown in the operations of block 108. Static control plane policer 42 can be configured to generally limit the rate or speed for all flows associated with a particular protocol. In the example of FIG. 2, policer 42 might be configured to generally limit the rate of all non-matching flow relating to the BGP protocol. The rate limit of a static control plane policer 42 can be any configurable flow rate. The limit of the dynamic policers 44 may be different or less than the limit of the static policers 40. If desired, the limit of the dynamic policers 44 may optionally be equal to or greater than the limit of the static policers 40.

During the operations of block 110, the policers can output the control plane packets to the local CPU 13. In the example of FIG. 2, the dynamic flow policers can convey the matching control plane packets to packet processing software 47 (see data path 68), whereas the static control plane policers can convey the non-matching control plane packets to packet processing software 47 (see data path 70). Packet processing software 47 may be implemented as a kernel driver, as part of the operating system of device 10, or more generally as part of some piece of code executed on device 10. If desired, packet processing software 47 can alternatively be implemented as a hardware component.

During the operations of block 112, packet processing software 47 may forward the control plane packets to flow table 48. CPU 13 can then update the flow table 48 based on the received data packets. In the example of FIG. 2, data packets received from a first BGP neighbor/peer A can be used to compile first flow data or statistics stored in a first portion of flow table 48, whereas data packets received from a second BGP neighbor/peer B can be used to compile second flow data or statistics stored in a second portion of flow table 48. This is exemplary. In general, flow table 48 can include any number of table entries for maintaining flow data or statistics for different flows associated with one or more network protocols.

During the operations of block 114, policer manager 50 can be configured to dynamically program a flow matching entry in CPU traffic policy database 34 based on the flow statistics gathered at flow table 48. This is illustrated by control path 78 in FIG. 2. For example, policer manager 50 can analyze the flow data in table 48 and determine that the flow from the BGP peer A needs to be rate-limited and thus program a corresponding flow matching entry in database 34.

During the operations of block 116, policer manager 50 can be configured to dynamically install a flow policer 46 based on the flow statistics gathered at flow table 48. This is illustrated by control path 80 in FIG. 2. For example, policer manager 50 can analyze the flow data in table 48 and determine that the flow from the BGP peer A needs to be rate-limited and thus install a corresponding flow policer to specifically limit the flow rate from peer A. In one embodiment, flow policer 46 can be a hardware component. In another embodiment, flow policer 46 can be implemented as a software component. The example of FIG. 3 in which the flow policer installation operations of block 116 are shown as being performed after the flow match entry programming operations of block 114 is illustrative. If desired, the operations of block 116 can be performed in parallel (simultaneously) with or before the operations of block 114.

The operations of blocks 114 and 116 can be performed in response to policer manager 50 determining that the flow rate for a particular flow might be causing control plane packets from other flows to be dropped by device 10. As another example, the operations of blocks 114 and 116 can be triggered in response to policer manager 50 detecting one or more untrusted flows and thus to install policers to specifically rate-limit those untrusted flows. As another example, the operations of blocks 114 and 116 can be triggered in response to policer manager 50 detecting flows that might have not followed a compliant protocol to establish a connection with device 10 and thus to install policers to specifically rate-limit those potentially non-compliant flows. In general, the operations of blocks 114 and 116 can be triggered when detecting potentially anomalous or misbehaving flows.

During the operations of block 118, policer manager 50 can optionally uninstall a flow policer from one or flow policers 44 and/or can optionally remove or delete a flow matching entry from CPU traffic policy database 34 if the corresponding flow is no longer causing dropped packets. As another example, the operations of block 118 can be performed in response to policer manager 50 determining that a previously untrusted flow can now be trusted. As another example, the operations of block 118 can be triggered in response to policer manager 50 determining that a previously misbehaving flow is no longer misbehaving.

Operating a network device operated in this way can be technically advantageous and beneficial to provide higher resolution and efficient control plane protection by targeting only one or more specific flows. The operations of FIG. 3 are exemplary. In some embodiments, one or more of the described operations may be modified, replaced, or omitted. In some embodiments, one or more of the described operations may be performed in parallel. In some embodiments, additional processes may be added or inserted between the described operations. If desired, the order of certain operations may be reversed or altered and/or the timing of the described operations may be adjusted so that they occur at slightly different times. If desired, the techniques described herein need not be limited to BGP and can be extended to other networking protocols.

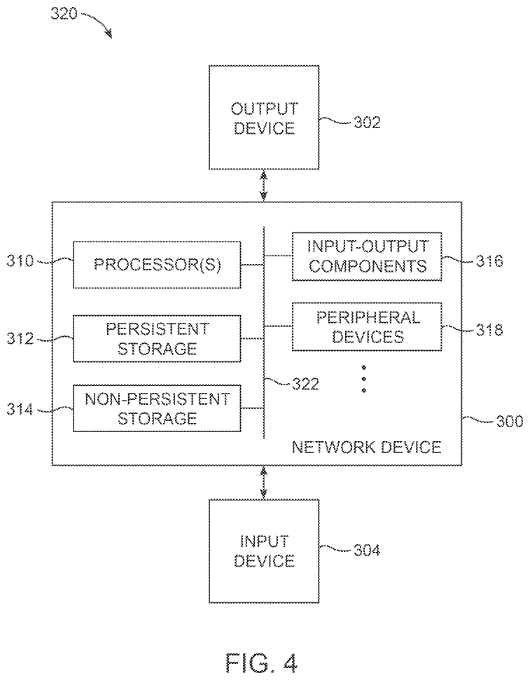

The foregoing embodiments may be made part of a larger system. FIG. 4 shows a system such as data processing system 320. Data processing system 320 may include a network device 300 optionally coupled to an input device 304 and/or an output device 302. Network device 300 may represent a network device 10 described in connection with the embodiments of FIGS. 1-3. Network device 300 may include one or more processors 310 (e.g., processing circuitry 14 of FIG. 1), storage circuitry such as persistent storage 312 (e.g., flash memory or other electrically-programmable read-only memory configured to form a solid-state drive, a hard disk drive, etc.), non-persistent storage 314 (e.g., volatile memory such as static or dynamic random-access memory, cache memory, etc.), or any suitable type of computer-readable media for storing data, software, program code, or instructions, input-output components 316 (e.g., communication interface components such as a Bluetooth® interface, a Wi-Fi® interface, an Ethernet interface, an optical interface, and/or other networking interfaces for connecting device 300 to the Internet, a local area network, a wide area network, a mobile network, other types of networks, and/or to another network device), peripheral devices 318, and/or other electronic components. These components can be coupled together via a system bus 322.

As an example, network device 300 can be part of a host device that is coupled to one or more output devices 302 and/or to one or more input devices 304. Input device(s) 304 may include one or more touchscreens, keyboards, mice, microphones, touchpads, electronic pens, joysticks, buttons, sensors, or any other type of input devices. Output device(s) 302 may include one or more displays, printers, speakers, status indicators, external storage, or any other type of output devices.

System 320 may be part of a digital system or a hybrid system that includes both digital and analog subsystems. System 320 may be used in a wide variety of applications as part of a larger computing system, which may include but is not limited to: a datacenter, a financial system, an e-commerce system, a web hosting system, a social media system, a healthcare/hospital system, a computer networking system, a data networking system, a digital signal processing system, an energy/utility management system, an industrial automation system, a supply chain management system, a customer relationship management system, a graphics processing system, a video processing system, a computer vision processing system, a cellular base station, a virtual reality or augmented reality system, a network functions virtualization platform, an artificial neural network, an autonomous driving system, a combination of at least some of these systems, and/or other suitable types of computing systems.

The methods and operations described above in connection with FIGS. 1-4 may be performed by the components of one or more network device(s) using software, firmware, and/or hardware (e.g., dedicated circuitry or hardware). Software code for performing these operations may be stored on non-transitory computer readable storage media (e.g., tangible computer readable storage media) stored on one or more of the components of the network device. The software code may sometimes be referred to as software, data, instructions, program instructions, or code. The non-transitory computer readable storage media may include drives, non-volatile memory such as non-volatile random-access memory (NVRAM), removable flash drives or other removable media, other types of random-access memory, etc. Software stored on the non-transitory computer readable storage media may be executed by processing circuitry on one or more of the components of the network device (e.g., using processing circuitry 14 of FIG. 1).

The foregoing is merely illustrative and various modifications can be made to the described embodiments. The foregoing embodiments may be implemented individually or in any combination.

What is claimed is:

1. A method of operating a network device having a packet processor and a central processing unit (CPU), the method comprising:
with the packet processor, receiving data packets;
determining whether the data packets comprise control plane packets to be processed by the CPU;
in response to determining that the data packets comprise control plane packets to be processed by the CPU, determining whether the data packets match a given flow; and
in response to determining that the data packets match the given flow, limiting a flow rate of the data packets sent to the CPU for processing by a first amount.

2. The method of claim 1, further comprising:
in response to determining that the data packets do not match the given flow, limiting a flow rate of the data packets sent to the CPU for processing by a second amount different than the first amount.

3. The method of claim 2, wherein determining whether the data packets comprise control plane packets comprises monitoring a destination address of the data packets.

4. The method of claim 2, wherein determining whether the data packets match the given flow comprises monitoring whether at least a portion of header information in the data packets matches an entry in a CPU traffic policy database on the packet processor.

5. The method of claim 2, further comprising:
with a dynamically configured policer, limiting the flow rate of the data packets sent to the CPU for processing by the first amount; and
with a statically configured policer, limiting the flow rate of the data packets sent to the CPU for processing by the second amount.

6. The method of claim 2, further comprising:
after determining that the data packets comprise control plane packets to be processed by the CPU, conveying the data packets from the packet processor to the CPU; and
updating a flow table on the CPU with flow data on the data packets.

7. The method of claim 6, further comprising:
with a policer manager on the CPU, monitoring the flow data from the flow table and dynamically installing a flow policer in the packet processor for limiting the flow rate of the data packets sent to the CPU for processing by the first amount.

8. The method of claim 7, further comprising:
with the policer manager, programming an entry in a CPU traffic policy database on the packet processor, wherein determining whether the data packets match the given flow comprises monitoring whether at least a portion of header information in the data packets matches the entry in the CPU traffic policy database.

9. The method of claim 7, further comprising:
with the policer manager, dynamically uninstalling the flow policer from the packet processor in response to determining that the data packets are not causing the CPU to drop data packets from other flows.

10. The method of claim 6, further comprising:
with a policer manager on the CPU, monitoring the flow data from the flow table and programming an entry in a CPU traffic policy database on the packet processor, wherein determining whether the data packets match the given flow comprises monitoring whether at least a portion of header information in the data packets matches the entry in the CPU traffic policy database.

11. The method of claim 10, further comprising:
with the policer manager, deleting the entry from the CPU traffic policy database in response to determining that the data packets are not causing the CPU to drop data packets from other flows.

12. A method of operating a network device comprising:
receiving data packets;
determining whether the data packets are associated with a given flow;
in response to determining that the data packets are associated with the given flow, conveying the data packets to a first policer; and
in response to determining that the data packets are not associated with the given flow, conveying the data packets to a second policer different than the first policer.

13. The method of claim 12, further comprising:
with the first policer, limiting a flow rate of the data packets to be processed to a first value; and
with the second policer, limiting a flow rate of the data packets to be processed to a second value greater than the first value.

14. The method of claim 12, further comprising:
before determining whether the data packets are associated with the given flow, determining whether the data packets comprise control plane packets to be processed in a control plane of the network device.

15. The method of claim 12, wherein determining whether the data packets are associated with the given flow comprises determining whether at least a portion of header information in the data packets match an entry in a traffic policy database stored on the network device.

16. The method of claim 15, further comprising:
gathering flow statistics on the given flow;
with a policer manager, monitoring the flow statistics and dynamically installing the first policer based on the flow statistics; and
with the policer manager, uninstalling the first policer when the flow statistics satisfy some criteria.

17. The method of claim 15, further comprising:
gathering flow statistics on the given flow; and
with a policer manager, monitoring the flow statistics and programming the entry in the traffic policy database based on the flow statistics.

18. A network device comprising:
control plane processing circuitry configured to execute an operating system of the network device; and
packet processing circuitry configured to:
receive data packets;
determine whether the data packets are destined for the control plane processing circuitry;
determine whether the data packets are part of a given flow;
rate limit the data packets by a first amount in response to determining that the data packets satisfy a set of criteria; and
rate limit the data packets by a second amount, different than the first amount, in response to determining that the data packets do not satisfy the set of criteria.

19. The network device of claim 18, wherein the packet processing circuitry comprises content addressable memory having a first set of entries used to determine whether the data packets are destined for the control plane processing circuitry and having a second set of entries used to determine whether the data packets are part of the given flow.

20. The network device of claim 19, wherein the control plane processing circuitry is further configured to:
store a flow table having flow statistics for the data packets; and
execute a policer manager configured to program the content addressable memory and to install a flow policer in the packet processing circuitry for rate limiting the data packets by the first amount based on the flow statistics.
